(19) United States
(12) Patent Application Publication
(10) Pub. No.: US 2009/0236812 A1
(43) Pub. Date: Sep. 24, 2009

(54) JOINT ARRANGEMENT FOR A VEHICLE

(75) Inventors: Dirk Mahlmann, Vechta (DE); Benjamin Ziebart, Wallenhorst (DE)

Correspondence Address: MCGLEW & TUTTLE, PC, P.O. BOX 9227, SCARBOROUGH STATION, SCARBOROUGH, NY, 10510-9227, US

(73) Assignee: ZF FRIEDRICHSHAFEN AG, Friedrichshafen (DE)

(21) Appl. No.: 12/299,927

(22) PCT Filed: May 8, 2007
(86) PCT No.: PCT/DE2007/000842

§ 371 Date: Nov. 7, 2008

(30) Foreign Application Priority Data
May 9, 2006 (DE) 10 2006 021 863.9

(51) Int. Cl. B62D 7/16; F16C 11/06

(52) U.S. Cl. 280/93.502; 403/140

(57) ABSTRACT

A joint arrangement for a vehicle is provided including a joint (7), which has a joint housing (8) and a pivot pin (9) mounted movably in relation thereto. The joint arrangement has a rod (4), which has a cavity (6) and which is connected to the joint (7). A sealing bellows (10) defines an interior space (11) in which the joint (7) is arranged at least partially. A gas-permeable connection (13) connects the cavity (6) of the rod (4) to the interior space (11) of the sealing bellows (10). At least one part of the gas-permeable connection (13) is formed by at least one bore (14), which is formed in the joint (7) and which opens into the cavity (6) of the rod (4).

### CROSS REFERENCE TO RELATED APPLICATIONS

This application is a United States National Phase application of International Application PCT/DE 2007/000842 and claims the benefit of priority under 35 U.S.C. § 119 of German Patent Application DE 10 2006 021 863.9 filed May 9, 2006, the entire contents of which are incorporated herein by reference.

### FIELD OF THE INVENTION

The present invention pertains to a joint arrangement for a vehicle, with a joint, which has a joint housing and a pivot pin mounted movably in relation thereto; with a rod, which has a cavity and which is connected to the joint; with a sealing bellows, which defines an interior space and in which the joint is arranged at least partially; and with a gas-permeable connection, which connects the cavity of the rod to the interior space of the sealing bellows.

### BACKGROUND OF THE INVENTION

Such joint arrangements are known from the state of the art and are used, e.g., for rack-and-pinion steerings, wherein the sealing bellows protects at least a part of the joint arrangement from environmental effects and dirt. Pressure fluctuations, which can be compensated by means of the gas-permeable connection, may occur within the sealing bellows during motions of the toothed rack.

A connection between a hollow rod and a housing, wherein a groove is provided in the wall of the rod on the front side, is known from JP 5-37644. Furthermore, two mutually opposite grooves are formed in the area of a thread on the inner wall of the rod.

A joint arrangement with a joint, which is connected to a hollow rod by means of a pin via a screw connection, is known from JP 63-104173. An axial groove, which extends in a thread and which passes over into a radial groove formed in a radial flange of the pin, is formed in the pin.

A ball and socket joint, whose housing bottom has an axially offset flange with an axially projecting pin, which meshes with a hollow rod, is known from JP 3-8066. Radial grooves, which pass over into axial grooves, which are formed in the jacket surface of the pin, are provided in the flange, which is provided with a wrench contact surface.

The drawback of this solution is that complicated contours, on which burs or increased tool wear may occur, are formed due to grooves combined with wrench contact surfaces.

A joint connection with a ball and socket joint housing, which is connected in one piece to an axial connection pin, which has an external thread and is screwed into a hollow toothed rack with a corresponding internal thread, is known from DE 43 31 291 C 1. After having been mounted, the toothed rack is in contact with a radial flange, into which the connection pin passes over on the ball and socket joint side. Vent grooves, which pass over into the radial flange, are provided in the connection pin.

The drawback of this solution is that the axial areas of the vent grooves pass through the external thread, which leads to a relatively complicated manufacture. Furthermore, the radial areas of the vent grooves extend in the front surface of the radial flange, which front surface can also be used as a contact surface during the pressing of the joint. This surface is reduced by the vent grooves, which in turn leads to restrictions in design.

### SUMMARY OF THE INVENTION

Based on this state of the art, a basic object of the present invention is to improve the joint arrangement mentioned in the introduction such that less complicated manufacture is possible and restrictions in design can be reduced.

The joint arrangement according to the present invention for a vehicle, especially a motor vehicle, has a joint, which comprises a joint housing and a pivot pin, which is mounted movably relative thereto; a rod, which has a cavity and which is connected to the joint; a sealing bellows, which defines an interior space and in which the joint is arranged completely or at least partially; and a gas-permeable connection, which connects the cavity of the rod to the interior space of the sealing bellows, wherein at least part of the gas-permeable connection is formed by at least one bore, which is formed in the joint and opens into the cavity of the rod.

Since the gas-permeable connection opens according to the present invention into the cavity of the rod via the bore formed in the joint, forming air guide grooves in a thread or in a front surface of the joint facing the rod can be avoided. In particular, it is possible for the gas-permeable connection to open into the interior space of the sealing bellows at a spaced location from the connection area between the joint and the rod, so that letting the gas-permeable connection pass through a wrench contact surface can, furthermore, be avoided. The gas-permeable connection can thus be functionally separated from a thread, a contact surface or a wrench contact surface, so that the drawbacks and restrictions mentioned in connection with the state of the art can be avoided or at least reduced. Furthermore, the bore preferably extends in the longitudinal direction of the rod.

Even though the term “bore” is used, the bore does not necessarily have to have been formed by drilling or by machining. In particular, it is possible to form the bore by drilling or by punching. The bore may also be formed during the casting of the joint housing and/or of the pivot pin, if the joint housing and/or the pivot pin are cast. Instead of the term bore, it would also be possible to use terms such as hole or cylindrical recess, which is especially elongated and/or permeable to gas on both sides or open.

The rod may be connected to the pivot pin, in which the bore extends. However, the rod is preferably connected to the joint housing, in which the bore is formed. The bore may be provided in a bottom of the joint housing, which faces away from or is located opposite an opening, through which the pivot pin extends from the joint housing. The bottom is made, in particular, in one piece with the joint housing.

The joint housing preferably has a housing recess, which is defined by a housing wall and in which the pivot pin is seated. The bore may open into the housing recess, so that the cavity is connected to the housing recess via the bore in a gas-permeable manner. Furthermore, the gas-permeable connection may have at least one groove, which adjoins the bore directly or indirectly, and which is formed within the joint housing and preferably opens into the interior space of the sealing bellows. The groove may be formed, e.g., in the housing wall and/or in a bearing shell, which is arranged in the joint housing and in which the pivot pin is mounted. It is thus possible to establish a gas-permeable connection between the bore and the interior space of the sealing bellows. In particular, a plurality of grooves may be provided. It is likewise possible for the at least one groove adjoining the bore not to extend up to the interior space of the sealing bellows and to end at a spaced location from this in the interior of the joint housing. A groove provided in the bearing shell may adjoin this groove, which is provided, e.g., in the wall, and open into the interior space.

Furthermore, it is possible for the gas-permeable connection to have at least one pin bore, which is formed in the pivot pin and directly or indirectly adjoins the bore, and which opens into the interior space of the sealing bellows. The connection between the bore and the pin bore is established preferably via the intermediary of the housing recess or of a part thereof. Furthermore, a pivot pin recess, which is open towards the pivot pin, and into which the at least one pin bore opens, may be provided in the pivot pin. In particular, a plurality of pin bores may be provided.

According to a variant of the present invention, the bore itself opens into the interior space of the sealing bellows and may extend for this purpose, e.g., obliquely in relation to the longitudinal axis of the rod. Furthermore, the gas-permeable connection may have at least one second bore, which adjoins the bore and which extends within the joint or the joint housing, wherein the two bores pass over into one another especially within the joint or the joint housing and are preferably not directed in parallel to one another. In particular, one of the bores extends in the direction of the longitudinal axis of the rod, whereas the other bore extends obliquely or at right angles to this longitudinal axis and preferably opens into the interior space of the sealing bellows in or in the area of an outer jacket surface of the joint housing. The two bores are preferably designed as blind holes, which pass over into one another within the joint, especially within the joint housing.

The rod may be connected to a steering gear and moved by means of the steering gear, especially displaced in the longitudinal direction of the rod. The rod is preferably designed here as a toothed rack, which forms a rack-and-pinion steering or a rack-and-pinion steering gear together with the steering gear. The sealing bellows may be sealingly in contact with the steering gear or with a housing of the steering gear, on the one hand, and with the pivot pin or with a coupling member connected thereto, on the other hand.

The joint is preferably a ball and socket joint, so that the pivot pin is designed as a ball pivot, which is mounted with its joint ball rotatably and pivotably in the joint housing.

The cavity formed within the rod extends especially in the longitudinal direction thereof and preferably up to the front side of the rod, which said front side faces the joint. The cavity may be axially limited within the rod or designed as a blind hole. As an alternative, the cavity may extend through the rod. Furthermore, a plurality of cavities may be provided in the rod.

The rod may be connected to a second joint and extend between these two joints. The two joints may be provided each with a bore opening into the cavity and have especially identical design.

Since the bores and grooves described here are part of a gas-permeable connection or form same, these are preferably free bores and free grooves.

All embodiments of the present invention may have a bearing shell, which is arranged in the joint housing and in which the pivot pin is mounted.

The present invention will be described below on the basis of preferred embodiments and with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partial sectional view of a rack-and-pinion steering according to the invention;

FIG. 2 is a sectional view of a ball and socket joint for the rack-and-pinion steering according to a first embodiment of the present invention;

FIG. 3 is a sectional view of a ball and socket joint for the rack-and-pinion steering according to a second embodiment of the present invention;

FIG. 4 is a sectional view of a ball and socket joint for the rack-and-pinion steering according to a third embodiment of the present invention;

FIG. 5 is a sectional view of a ball and socket joint for the rack-and-pinion steering according to a fourth embodiment of the present invention;

FIG. 6 is a sectional view of a ball and socket joint for the rack-and-pinion steering according to a fifth embodiment of the present invention;

FIG. 7 is a sectional view of a ball and socket joint for the rack-and-pinion steering according to a sixth embodiment of the present invention;

FIG. 8 is a view showing a plurality of groove profiles;

FIG. 9 is a view showing a plurality of groove shapes; and

FIG. 10 is a view showing different numbers of grooves.

### DESCRIPTION OF THE PREFERRED EMBODIMENTS

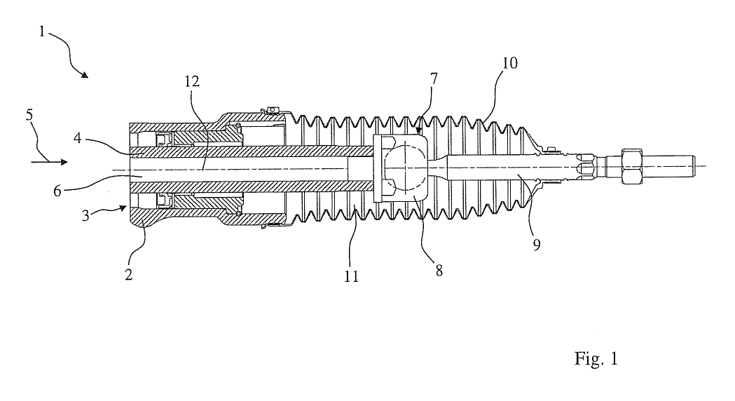

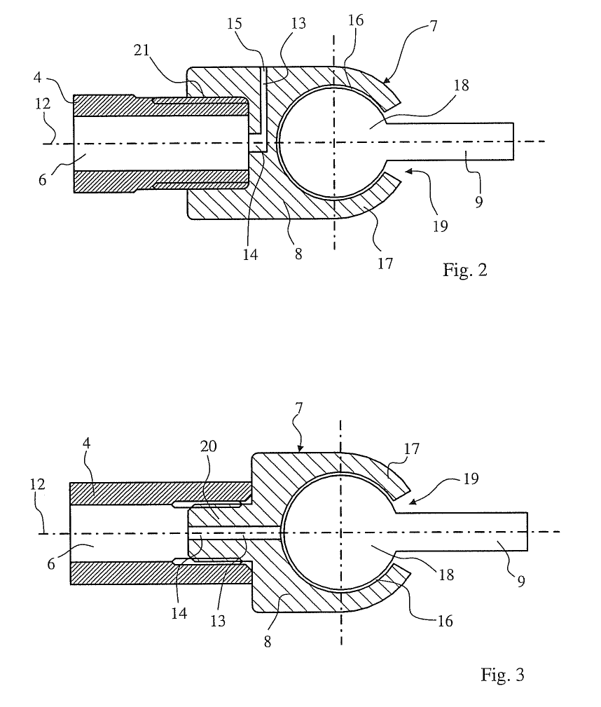

Referring to the drawings in particular, FIG. 1 shows a partial sectional view of a rack-and-pinion steering 1, wherein a toothed rack 4, which is displaceable in the direction of arrow 5 and in the direction opposite the arrow 5 by means of the steering gear 3, is mounted in a housing 2 of a steering gear 3. The toothed rack 4 has a recess 6 and is connected at least one end to a ball and socket joint 7. The ball and socket joint 7 has a joint housing 8 and a ball pivot 9, which is mounted in same rotatably and pivotably and which is seated with a joint ball 18 (see FIG. 2) in a housing recess 16 (see FIG. 2), which is formed in the joint housing 8 and is defined by a wall 17 (see FIG. 2) of the joint housing 8. The ball pivot 9 extends through an opening 19 (see FIG. 2) provided in the ball and socket joint housing 8 and out of the ball and socket joint housing, and a sealing bellows 10 is sealingly in contact with one end with the ball pivot 9 outside the ball and socket joint housing 8. With its other end, the sealing bellows 10 is sealingly in contact with the housing 2 of the steering gear 3, so that an interior space 11, which is defined by the sealing bellows 10 and in which the ball and socket joint housing 8, an end area of the toothed rack 4 as well as a part of the ball pivot 9 are arranged, is formed between the two ends of the sealing bellows 10. The longitudinal axis of the toothed rack 4 is designated by reference number 12, and arrow 5 extends in parallel to or in the direction of the longitudinal axis 12.

If the toothed rack 4 is displaced by means of the steering gear 3 in the direction opposite the direction of arrow 5, the sealing bellows 10 is compressed or flattened, which can lead to an increase in the pressure of the air present in the interior space 11 of the sealing bellows 10. If, by contrast, the toothed rack 4 is displaced by means of the steering gear 3 in the direction of arrow 5, the sealing bellows 10, designed as an expansion bellows, is stretched or expanded, which can lead to a drop in the pressure of the air present in the interior space 11 of the sealing bellows 10. In order for such pressure fluctuations to be able to be compensated, the rack-and-pinion steering 1 has a gas-permeable connection 13 (see FIG. 2), which connects the cavity 6 of the toothed rack 4 to the interior space 11 of the sealing bellows 10 in an air-permeable manner. Air can thus be removed from the interior space 11 through the cavity 6 or air can be fed into the interior space 11. If the cavity 6 does not extend entirely through the toothed rack 4, the air can be bypassed, e.g., via the housing 2 of the steering gear 3.

FIG. 2 shows the ball and socket joint 7 of the rack-and-pinion steering 1 according to a first embodiment of the present invention in a sectional view, wherein cavity 6 is connected via the gas-permeable connection 13 to the interior space 11 of the sealing bellows 10, not shown here, in an air-permeable manner, where the interior space 11 is arranged outside the ball and socket joint housing 8. The gas-permeable connection 13 has an axial bore 14 formed in the ball and socket joint housing 8 and at least one radial bore 15, which is formed in the ball and socket joint housing 8 and passes over into the axial bore 14 within the ball and socket joint housing 8.

According to the first embodiment, the ball and socket joint housing 8 has, at its end facing the toothed rack 4, a pot-shaped recess 21 with an internal thread, which meshes with an end of the toothed rack 4, which said end faces the ball and socket joint housing 8. The toothed rack 4 and the ball and socket joint housing 8 are thus screwed together.

Further embodiments of the present invention will be described below, and identical or similar features are designated by the same reference numbers in all embodiments.

FIG. 3 shows a sectional view of the ball and socket joint 7 according to a second embodiment of the present invention, wherein the gas-permeable connection 13 has an axial bore 14, which extends from cavity 6 through the joint housing 8 up to the recess 16. Bore 14 is connected to the interior space 11 of the sealing bellows 10, which is not shown here, in an air-permeable manner via the opening 19 and via intermediate spaces present in the recess 16 between the joint ball 18 and the wall 17.

The joint housing 8 has an axial pin 20, which is made especially in one piece with same, and which is provided with an external thread and extends into the interior space 6 of the toothed rack 4. An internal thread, which meshes with the external thread of pin 20, is formed in the area of the end of the toothed rack 4, which said end faces the ball and socket joint 7, on the inner wall of the toothed rack 4. The ball and socket joint housing 8 and the toothed rack 4 are thus screwed together.

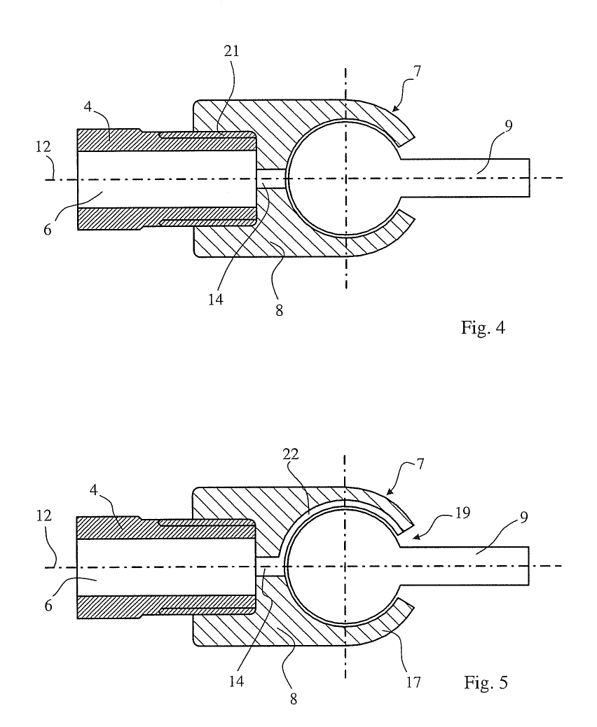

FIG. 4 shows a sectional view of the ball and socket joint 7 according to a third embodiment of the present invention, wherein the third embodiment is identical to the second embodiment with the exception of the connection between the joint housing 8 and the toothed rack 4. However, according to FIG. 4, a pot-shaped recess 21, which has an internal thread, which meshes with an external thread formed on the toothed rack 4, is provided in the ball and socket joint housing 8. The connection between the toothed rack 4 and the ball and socket joint housing 8 is thus formed by a screw connection equivalent to the first embodiment.

FIG. 5 shows a sectional view of the ball and socket joint 7 according to a fourth embodiment of the present invention, wherein at least one groove 22, which extends, starting from the bore 14, up to the opening 19, is provided in wall 17 in the ball and socket joint housing 8. Aside from the groove 22, the fourth embodiment is identical to the third embodiment. However, contrary to this, the exchange of air between cavity 6 and the interior space 11 of the sealing bellows 10, not shown, is facilitated in the fourth embodiment because of the groove 22.

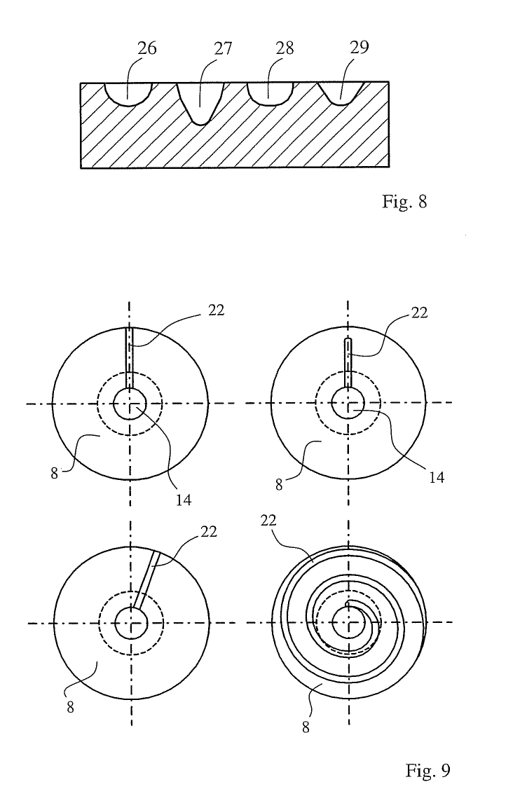

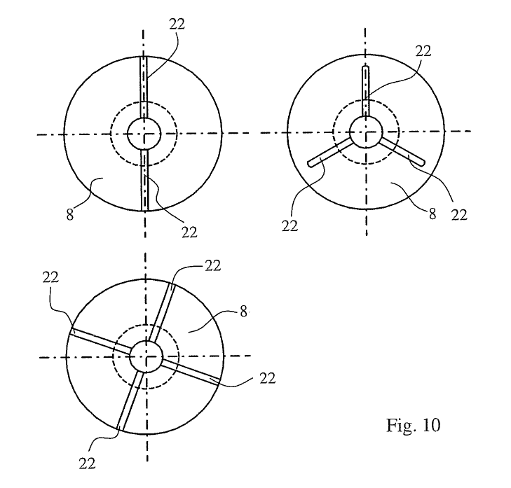

The at least one groove 22 may have one of the groove profile shapes 26, 27, 28 or 29 shown in FIG. 8 and/or one of the groove shapes shown in FIG. 9. It is seen, in particular, in FIG. 9 that, according to a variant of the embodiment, the groove or grooves 22 do not have to extend up to the opening 19. A spirally extending groove 22 is also possible. Furthermore, FIG. 10 shows that a different number of grooves 22 may be provided.

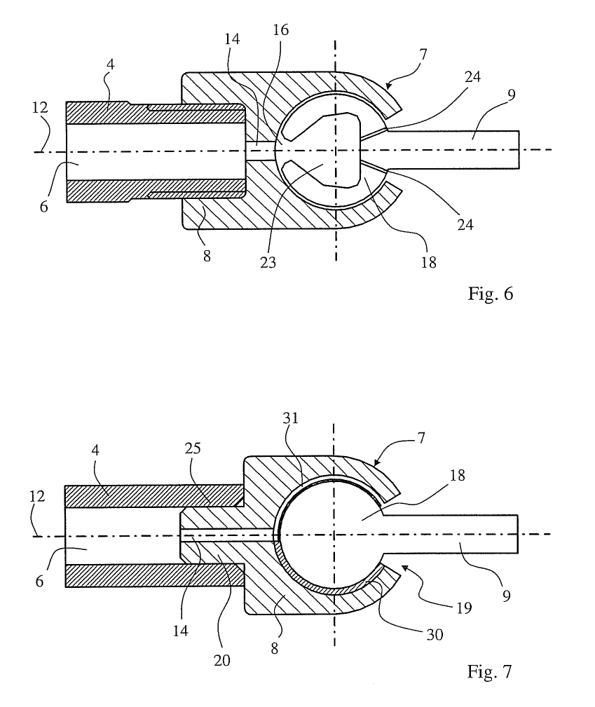

FIG. 6 shows a sectional view of the ball and socket joint 7 according to a fifth embodiment of the present invention, in which a recess 23, which is open towards the recess 16, is provided in the joint ball 18 of the ball pivot 9. Furthermore, at least one bore 24, which extends, starting from recess 23 through the ball pivot 9 up to the interior space 11 of the sealing bellows 10, not shown here, and thus forms an air-permeable connection between recess 23 and the interior space 11, is formed in the ball pivot 9. FIG. 6 shows two such bores 24. Since the recess 23 is open towards the recess 16, the cavity 6 is also connected to the interior space 11 in an air-permeable manner.

FIG. 7 shows a sectional view of the ball and socket joint 7 according to a sixth embodiment of the present invention, which is essentially identical to the second embodiment. However, contrary to this, a bearing shell 30, in which the joint ball 18 is mounted rotatably and pivotably, is arranged in the sixth embodiment within the recess 16 between the joint ball 18 and the housing wall 17. At least one groove 31, which adjoins the bore 14 and extends up to the opening 19, is provided in the bearing shell 30. An air-permeable connection is thus formed between the cavity 6 and the interior space 11 of the sealing bellows 10, which is not shown here. The groove profile shapes, groove shapes and/or numbers of grooves shown in FIGS. 8, 9 and 10 are correspondingly possible for the at least one groove 31. In addition or as an alternative to the groove(s) formed in the bearing shell, holes, which form a part of the gas-permeable connection, may also be formed in the bearing shell.

Even though it is shown in the sixth embodiment only, it is possible, in principle, in all embodiments for a bearing shell 30 to be arranged within the recess 16 between the joint ball 18 and the housing wall 17. The bearing shell may have one or more grooves and/or holes for guiding air here.

While specific embodiments of the invention have been shown and described in detail to illustrate the application of the principles of the invention, it will be understood that the invention may be embodied otherwise without departing from such principles.

1. A joint arrangement for a vehicle, the joint arrangement comprising:
a joint with a joint housing and a pivot pin mounted movably relative thereto;
a rod with a cavity, said rod being connected to the joint;
a sealing bellows, which defines an interior space, the joint being arranged at least partially in the interior space; and
a gas-permeable connection connecting the cavity of the rod to the interior space of the sealing bellows at least one part of the gas-permeable connection being formed by at least one bore, the bore being formed in the joint, the bore opening into the cavity of the rod.

2. A joint in accordance with claim 1, wherein the rod is connected to the joint housing and the bore is formed in the joint housing.

3. A joint in accordance with claim 2, wherein the joint housing has a housing recess, which is defined by a housing wall, the pivot pin being seated in the housing recess, wherein the bore opens into the housing recess.

4. A joint in accordance with claim 3, wherein the gas-permeable connection has at least one groove, which adjoins the bore at least indirectly and which is formed within the joint housing in the housing wall and opens into the interior space of said sealing bellows.

5. A joint in accordance with claim 3, wherein the pivot pin is seated in the housing recess via a bearing shell and the gas-permeable connection has a groove, which adjoins the bore at least indirectly, the groove being formed in the bearing shell and opening into the interior space of the sealing bellows.

6. A joint in accordance with claim 1, wherein the gas-permeable connection has at least one pin bore, which is formed in the pivot pin, which adjoins the bore at least indirectly and which opens into the interior space of the sealing bellows.

7. A joint in accordance with claim 1, wherein the bore opens into the interior space of the sealing bellows.

8. A joint in accordance with claim 1, wherein the gas-permeable connection includes at least one second bore to provide two bores, the at least one second bore opening into the interior space of the sealing bellows, and adjoining the bore within the joint or within the joint housing.

9. A joint in accordance with claim 8, wherein the two bores do not extend in parallel to one another.

10. A joint in accordance with claim 1, wherein the rod is connected to a steering gear and is movable by means of the steering gear.

11. A joint in accordance with claim 10, wherein the sealing bellows is sealingly in contact with the steering gear or a housing of the steering gear and sealingly in contact with the pivot pin or with a coupling member connected to the pivot pin.

12. A joint in accordance with claim 1, wherein the rod is a toothed rack.

13. A joint in accordance with claim 1, wherein the joint is a ball and socket joint and said pivot pin is a ball pivot with a joint ball, mounted rotatably and pivotably in the joint housing.

14. A joint arrangement for a vehicle, the joint arrangement comprising:
a joint with a joint housing and a pivot pin mounted movably relative thereto;
a rod having an inner rod surface, said inner rod surface defining a cavity, said rod being connected to said joint;
a sealing bellows mounted for movement such that said sealing bellows is movable from a compressed position to a stretched position, said sealing bellows having an inner sealing bellows surface, said inner sealing bellows surface defining an interior space, at least a portion of said joint being arranged in said interior space; and
a gas-permeable connection, said interior space of said sealing bellows being in communication with said cavity of said rod via said gas-permeable connection, at least a portion of said gas-permeable connection including at least one bore formed in said joint, said bore being in communication with said cavity of said rod, said interior space of said sealing bellows receiving gas from said cavity of said rod via said gas-permeable connection when said sealing bellows is in said stretched position, said cavity receiving gas from said interior space of said sealing bellows via said gas-permeable connection when said sealing bellows is in said compressed position.

15. A joint in accordance with claim 14, wherein said rod is connected to said joint housing and said bore is formed in said joint housing, said joint housing having a housing wall, said housing wall defining a housing recess, at least a portion of said pivot pin being arranged in said housing recess, said bore being in communication with said housing recess.

16. A joint in accordance with claim 15, wherein said gas-permeable connection has at least one groove, said at least one groove being in communication with said bore, said at least one groove being formed within said joint housing in said housing wall, said groove being in communication with said interior space of said sealing bellows.

17. A joint in accordance with claim 15, further comprising a bearing shell, wherein said pivot pin is seated in said housing recess via said bearing shell, said gas-permeable connection having a groove, said groove being in communication with said bore, said groove being formed in said bearing shell, said groove being in communication with said interior space of said sealing bellows.

18. A joint in accordance with claim 14, wherein said gas-permeable connection has at least one pin bore, said pin bore being formed in said pivot pin, said pin bore being in communication with said bore and said interior space of said sealing bellows.

19. A joint in accordance with claim 14, wherein said bore opens into said interior space of said sealing bellows.

20. A joint in accordance with claim 14, wherein said gas-permeable connection includes at least a second bore to provide two bores, said at least one second bore opening into said interior space of said sealing bellows, said at least one second bore being in communication with said bore within said joint or within said joint housing, said rod being connected to a steering gear, said rod being movable via said steering gear, said sealing bellows being sealingly in contact with said steering gear or a housing of said steering gear and sealingly in contact with said pivot pin or with a coupling member connected to said pivot pin.
